(19) United States
(12) Patent Application Publication
(10) Pub. No.: US 2005/0149582 A1
(43) Pub. Date: Jul. 7, 2005

(54) Method and system for synchronization of copies of a database

(76) Inventors: Joseph T. Wissmann, Chelmsford, MA (US); Michael W. Cross, Portsmouth, NH (US)

Correspondence Address: BROWN, RAYSMAN, MILLSTEIN, FELDER & STEINER LLP, 900 THIRD AVENUE, NEW YORK, NY, 10022, US

(21) Appl. No.: 10/748,127

(22) Filed: Dec. 29, 2003

(51) Int. Cl. G06F 17/30

(52) U.S. Cl. 707/201

(57) ABSTRACT

Disclosed is a lightweight database migration framework that allows schema definitions and incremental migrations to be pushed out to target local computers. The framework facilitates complex migrations by using either SQL script or programmatic migration methods to target local computers. Developers can download migration scripts from messages that are pushed to them, by electronic mail or otherwise, to synchronize their local database without the need to visit a central server. A base schema may be maintained via a set of incremental migration scripts, which generally correspond to milestone releases. In some embodiments, the scripts are specified via an XML document. The framework deduces a target database's schema version and automatically applies the necessary migration path to reach a target schema version. There is no need to visit a central server. Thus, there is no need to manage and maintain centralized server. Also, the migration scripts can be SQL scripts or code that executes complex data manipulation. The system encodes version histories by storing the migration scripts in a history folder, and facilitates the creation and migration to an earlier arbitrary schema version by reversing the operations performed using migration scripts executed after the arbitrary schema was created.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to a system and method for synchronization of copies of a database. More particularly, the present invention provides a lightweight database synchronization and migration framework for pushing schemas and migration scripts to database developers, labs, or production systems such that these artifacts can be delivered very flexibly as a natural part of a development or product upgrade cycle.

Managing the design and creation of a database is a continual process for database and application developers. Database object definitions (such as tables, views, indexes, etc.) are continually changed or added during development. Developers may use graphical user interface (GUI)-based tools, or craft structured query language (SQL) code to make changes to create their required database objects. The development process is quite difficult to manage when there are a large number of geographically dispersed developers and test engineers, and an extensive install base. Engineers need to evolve their versions of the database on which they are working at different paces. The net result of the developers' work on the database schema is that many different geographically dispersed versions of the database will exist using various schema versions at different locations. The developer and labs must be able to upgrade on an as needed basis to a particular version of a database. Installed systems similarly require a flexible mechanism for upgrading, although typically not at a rapid pace.

The inventors have recognized at least three core challenges in database development, which are: keeping the databases under development synchronized across many systems; allowing these copies of the database system under development to evolve at their own required pace; and facilitating migration without data loss.

In order to synchronize their database, developers may delete their existing databases and replace it with a new version stored at a centralized location. This is a simple process, but a major disadvantage is that all data is lost from the developer's existing database. This may be acceptable for a single developer, but may not be acceptable for a test database where significant effort was expended to populate it with test data. Further, this is unacceptable for a live database. Thus, a mechanism for delivering and synchronizing the different schemas while avoiding this problem is required.

In order to preserve data, many current products use migration scripts that carry one version of a database forward to a later version as required. Typical migration scripts allow changes to be read from a central database definition, or the download of scripts from a centralized server. These products typically provide a mechanism where developers maintain a master database during development to provide the other developers with their schema changes. These products typically rely on a centralized server from which distributed databases can be synchronized. An “up-to-date” version of the database is kept on the centralized server. Other databases can be compared against this central database, and differences highlighted. The products provide tools for visualizing database differences, and for generating the migration scripts, with many limitations. This centralized approach can be problematic for worldwide development organizations due to the need to maintain central databases for synchronization. In addition a support structure must typically be established to facilitate access to the central server (or perhaps a set of servers) in various geographical locations. This is a problem for a global development organization where access to central servers can be a problem. Even if multiple servers are deployed world-wide, these servers must be synchronized. In addition, such solutions are not tightly integrated with source control or other code delivery mechanisms. This is particularly important for developers since a packaging of both the database version, database upgrades, and application source code makes code evolution seamless.

Existing tools may be used to generate DDL files, and limited migration scripts, that can be executed on a target database. However, they do not package historical versions of a database along with migration code, or a means for delivery of the migration code.

Further, developers and support groups are typically not able to create an arbitrary schema version, as they sometimes have the need to do for troubleshooting, mainly because centralized servers tend to maintain only the “latest” version of the database. For example, engineers must sometimes recreate a particular schema version suited for their current code base, which is typically tied to some release point of a development cycle. It occasionally happens that developers have a need to create a particular schema version to test or recreate a problem. However, a central server will typically not maintain arbitrary schema versions for synchronization. In this regard, current centralized synchronization solutions tend not to easily facilitate much flexibility.

### BRIEF SUMMARY OF THE INVENTION

The present invention addresses, among other things, the problems discussed above with using current database migration tools in development.

The present invention provides for delivery of migration scripts in a framework. The scripts and/or framework can be embedded in any source control system for unambiguous delivery of the proper database for a specific code release. The invention also allows development and test teams to pull database definitions and associated schema changes from a code repository that inherently maintains incremental schema versions.

Using the framework, developers can synchronize databases by first determining satisfactory solutions to problems on their local copy of the database. The incremental changes are incorporated into the synchronization framework. The changes are pushed out to all developers via any mechanism deemed appropriate by the organization. To this end, the invention can be seamlessly embedded in any code delivery mechanism, and in particular code versioning systems such as Rational ClearCase or Visual Source Safe. When used in this manner, when developers establish a specific version of the code stream, they automatically acquire the ability to establish a database suitable for that code. This simple integration with source code version control systems, provides a powerful mechanism for keeping database schemas and evolution in synch with an evolving code base. Running systems, labs or production systems, may acquire the synchronization framework and updates by any electronic delivery mechanism, or simply downloading from a file server.

In accordance with some aspects of the present invention, a lightweight database migration framework is provided that allows schema definitions and incremental migrations to be pushed out to target local computers. The framework facilitates complex migrations by using either SQL script or programmatic migration methods to target local computers. Developers can download migration scripts within the framework from messages that are pushed to them, by electronic mail, code release mechanisms, or otherwise, to synchronize their local database without the need to visit a central server, other than perhaps those required for development purposes.

A base schema and incremental changes may be maintained via a set of incremental migration scripts. In some embodiments, the framework is specified via an XML document. The framework allows developers to include a script, which can, for example, deduce a target database's schema version and apply the necessary migration path to reach a target schema version. The migration scripts can be SQL scripts or code that executes complex data manipulation.

Some embodiments work with the tools mentioned in the Background section above. The visual difference and migration script generation tools can be used as a precursor to create migration scripts. However, these tools can typically only produce standard database migration scripts, which sometimes may even cause data loss if they are run against a local schema. Specifically, the auto-generated scripts cannot execute updates that require application specific transformations requiring application logic that is not embedded in the database. For this and other reasons, a developer or database master may want to further modify a script created by a current script generation tool to create a more complex migration script. Using current systems, developers are forced to obtain migration scripts locally to their respective copies of the database perhaps after comparing their local copy to a master copy. The further modifications made by the developer who initially made the modifications to the schema would have to be reproduced by each developer for their local database each time the developer performs a comparison of his or her local database to the master database. Different developers may not recognize the modifications that would need to be performed to the migration script after they use their local script generation tool to recreate the initial migration script. In this respect, the present invention provides a universal distribution framework that allows a migration script that has been modified by a developer to be distributed to all developers in the development group, without the need to recreate any modifications made by the developer who initially created the migration script.

Another advantage of the system of the present invention is that it encodes version histories by storing the migration scripts in a history folder, and facilitates the creation and migration from an earlier arbitrary schema version. As noted above, this historical information can be tightly coupled to versioned code releases by incorporating the framework in a version control system.

To further summarize, the system and method of the present invention provides for synchronization of copies of a database. Changes that are made to a schema of a first copy of the database and migration scripts reflecting those changes are incorporated into the framework. The framework containing the migration script reflecting these changes is sent to the location of one or more other copies of the database for executing to update the one or more other copies of the database. At least one of the one or more other copies of the database may comprise a master copy of the database. The step of sending may comprise sending the framework containing the migration script by standard development version control systems, electronic mail or other means, such as by a physical mail service, to each of the database copy locations, or through any file sharing service where code releases are available. If physical mail is used, the migration script is copied to a floppy disk or other removable storage device, which is mailed to each of the database copy locations. As the framework containing the migration script is received at each database copy location, it can be executed to update the local database.

Some embodiments use a server computer and master database as a version control system allowing developers to delay updating their local copies of the database so as not to complicate problems or bugs on which the developers are working. This allows the developers to resolve bugs or problems before complicating their work by updating to a current version, but allows the developers to nevertheless upgrade to the most current version of the database when they are ready to do so. Once a developer is ready to update the schema of their copy of the database, or “catch-up” to the current version after not updating their copy for several updates that have been available, the developer requests, or downloads the latest synchronization files and the framework executes the database upgrade on the developer's local machine.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating a networked system for providing a lightweight database synchronization and migration framework according to one embodiment of the invention;

FIG. 2 is a flow diagram illustrating the steps performed to track changes in a developer's local database and to generate a migration script based on those changes;

FIG. 3 is a flow diagram illustrating a method for distributing a migration script from a developer's computer of FIG. 1 using the framework or code version control system of the present invention, and executing the framework or migration scripts downloaded from the version control system on the various other computers of FIG. 1; and

FIG. 4 is a flow diagram illustrating the steps performed by the schema software of FIG. 1 in order to recreate an arbitrary schema that existed in time.

### DETAILED DESCRIPTION OF THE PREFERRED EMBODIMENTS

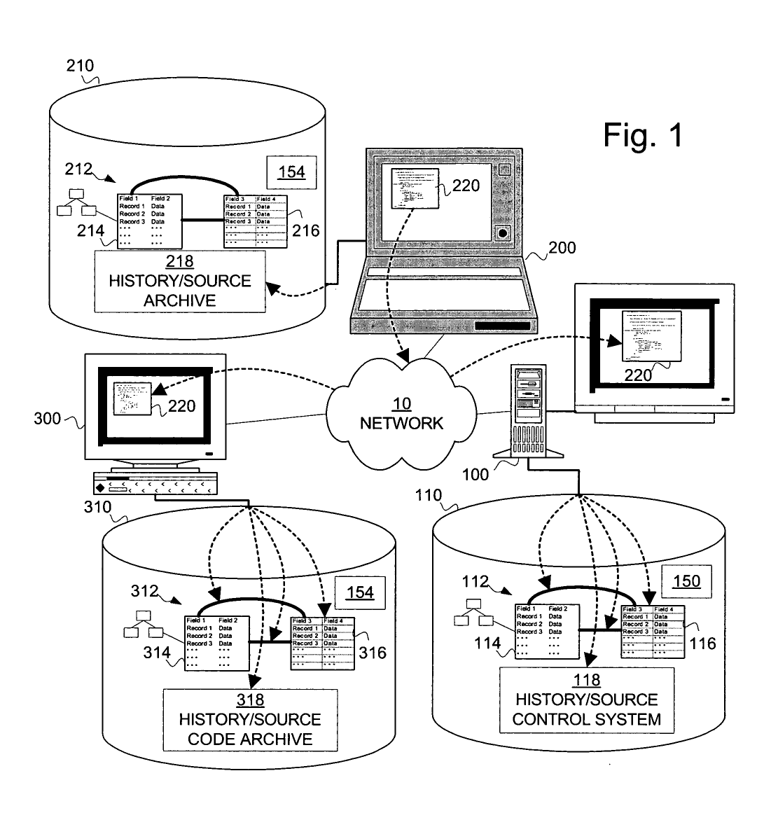

Preferred embodiments of the invention are now described with reference to the drawings. In accordance with the invention, and with reference to FIG. 1, a block diagram illustrates a networked system for providing a lightweight database synchronization and migration framework according to one embodiment of the invention. In the embodiment of FIG. 1, a network 10 provides for data communication between two or more electronic devices or computers 100, 200 and 300 having re-writable storage devices 110, 210 and 310, such as hard disks, flash memory, safe random access memory (safeRAM) or the like, capable of storing copies of a database under development 112, 212 and 312. Although not necessary, one computer 100 may act as a server, storing a base or master copy of the database 112 which can be used to keep track of the current master schema.

Preferably, initial copies of a first version of the database 112, 212 and 312 are distributed and stored in the storage devices 110, 210 and 310. The initial copies provide a base that can be agreed upon by the developers. Further, some basic stylistic rules for database changes may be agreed upon by developers, but such rules are not necessary. For example, one rule that may be helpful is for the developers to agree that all date fields will use Y2K compliant four-digit numbers. Those skilled in the art would recognize other similar rules for database development that may be useful.

The initial copies of the database 112, 212 and 312 contain duplicates of at least one table 114, 214 and 314. However, more likely, the developers would have agreed on several related tables to include in the initial database depending on the type of database application being developed. If the database 112 is maintained as a master copy, it is typically maintained by a database development team.

Schema migration software 150 may be stored in the storage device 110, and possibly storage devices 210 and 310 of each computer 100, 200 and 300 for execution in the processor of each computer 100, 200 and 300. The schema migration software 150 may include, or work with, software currently in use. For example, existing software that provides tools for visualizing database differences and for generating migration scripts can be used with little or no modification. Existing software which performs these tasks includes SQL Compare, available from Red-Gate Software of Cambridge, United Kingdom. Such software can be used to compare differences between two databases (e.g. 212), a master and a target database 112. If such software is used, it would typically reside on the master server 100 and be used by a database team to manage an evolving master copy 112. Changes made to a local database 212, along with migration scripts can be incorporated into the invention as an incremental change to a master database on server 100. All the other versions of the database can upgrade to these incremental changes when they receive, or pull, the latest schema definitions. The invention packages historical changes so the developer can create or, when feasible, migrate their database to the latest version.

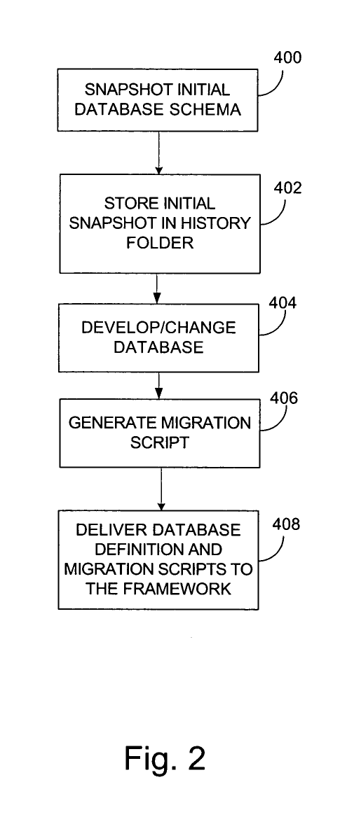

With reference to FIG. 2, a flow diagram illustrates the steps performed to track changes in a developer's local database and to incorporate desired changes in the invention's database definition and migration scripts into a framework (220 in FIG. 1). Using computer 200 as an example, an initial snapshot of the developer's local database 212 is made before a set of changes are begun by the developer, step 400. In some embodiments, just the schema definition may be stored in the snapshot, without actual tables or any test data. With reference back to FIG. 1, the schema management software stores the snapshot of the schema of the database 212 in a local history folder 218, step 402 in FIG. 2. The developer then implements the changes to the database 212 needed to solve the various problems the developer needs to solve to develop the portion of the database to which the developer is assigned, step 404.

An example is illustrated in database 212 in FIG. 1, in which the developer has added a new table 216 to the schema of database 212. A link is shown between a field 1 in table 214 and field 3 in table 216 to illustrate the table's relationship in the database 212. After the developer has made changes to the local schema, the developer may decide to create a migration script for inclusion in a framework (220 in FIG. 1), step 406 in FIG. 2. In order to accomplish this step, the schema stored in the history folder 218 is compared to the schema of the database 212 in its changed state, and the database migration script is generated based on the changes. The previously referred to SQL Compare product available from Red-Gate Software of Cambridge, United Kingdom, may be used to accomplish this step, which would be configured to compare the schema stored in the history folder 218 to the newly changed schema of the local database 212, instead of comparing the local database 212 to a master database, and to generate SQL code for the migration script 150 accordingly. However, a developer may further make changes to the generated SQL code as needed, for example, to compensate for shortcomings of the automatically generated SQL code. Alternatively, a developer may forego schema management software 150 and manually create migration scripts.

After the generation of a migration script, the changes are incorporated into the database definition and migration framework 220, step 408. These changes may be delivered to computer 100, which may maintain a master version subsequently delivered to all developers.

In some embodiments, the framework for migration script delivery may be embedded in a version control system, which may be part of the schema software 150. In those embodiments, the framework provides a seamless mechanism for developers to take advantage of the inherent capabilities of the version control system to synchronize changes to the schema along with changes to the corresponding code base. The history folders 118, 218 and 318 may store various versions of the source code base, which is controlled by the version control system portion of the schema software 150. When a developer downloads updates to the code base to update the code on a local computer 200 or 300, the schema software provides a download for a framework 220 containing corresponding migration scripts. Alternatively, the download of updated code may be included in the framework along with the migration scripts.

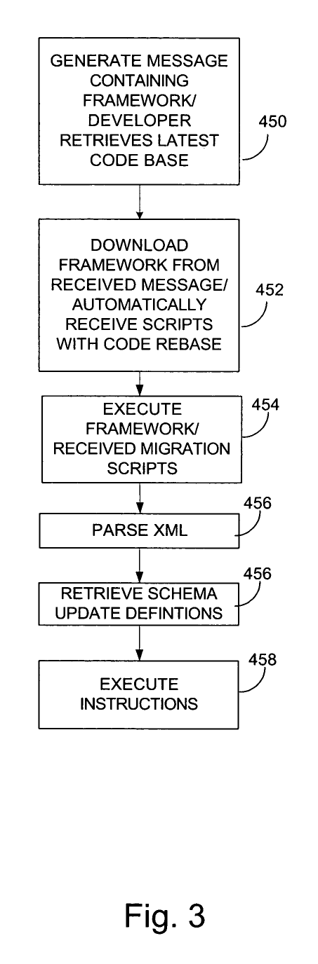

In some embodiments, the framework comprises an XML-based framework 220 for enclosing the scripted instructions for the database definition and updating database schema. Specifically, the update instructions within the XML script framework 220 can be (1) one or more SQL Scripts, (2) one or more executable programs or sets of instructions (for example, Java code), (3) SQL code, or (4) a derivative of SQL code such as PLSQL. Other forms of instructions known to those skilled in the art can be generated to include with the XML script 220. Further, the instructions within the XML script 220 may be broken up into sets instructions, each set associated with an incremental schema version. Using XML, the SQL-based instructions are tokenized files which comprise the framework 220. The “sqlfile” node indicates that a SQL file embodies the migration step. The tokens can replace standard database constructs that can vary by machine. These can include the database and schema name. The XML instruction document 220 includes the file name and location. As explained below with respect to FIG. 3, when the framework 220 is delivered to the receiving computer, a browser or other software 154 on the receiving computer can be used to execute the XML files 220, by performing token substitution, or parsing, and executing the SQL instructions within the framework 220.

The following is an example of the XML script 220 containing an SQL-based instruction generated from the addition of table 216 of FIG. 1:

```
<?xml version=“1.0” encoding=“UTF-8” ?>
<schemamigration version=“1.0”>
    <versionnumber tablename=“schemaversion” column=
    “devversion” />
    <schemaupdate version=“101”>
        <sqlfile db=“DB2”, dir=“.//subdir” filename=“migrate1.sql/>
        <java db=“DB2” classname=
        “com.mycompany.db.migration.someclass”>
            <arg value=“abc”/>
            <arg line=“a b c d”/>
        </java>
        <sql db=“DB2”/>
            -- create a table
            CREATE TABLE @ASCHEMA@.MYDATA (
                OID CHAR(20) NOT NULL,
                STATUS SMALLINT NOT NULL,
                DESC VARCHAR(80) ,
                CONTENT VARCHAR(255) NOT NULL)
            IN @SOMETABLESPACE@
            -- create
        </sql>
    </schemaupdate>
etc...
</schemamigration>
```

While this example adds a table, those skilled in the art would recognize that, depending on the changes made by the developer to the database 212, scripts in the migration script framework 220 may perform other database changes typically performed by the developer, such as addition or subtraction of fields in existing tables, deletion of tables, or establishment of indexes.

If instructions that are not SQL instructions are used in a migration script, such as executable code for example, the executable code can be of any type that can be executed on the receiving computer 100, 200 or 300. Executable Java code, for example, can be given a dedicated node in the framework 220. The Java executable node is identified by the keyword “java”. A class name is specified with optional command line arguments. The framework 220 on the receiving computer executes the indicated class with the arguments.

With reference to FIG. 3, a flow diagram illustrates a method for distributing the migration script framework 220 and executing it on the various other computers 100 and 300. Depending on the options set in a software delivery mechanism on computer 100, the schema and migration script framework 220 may automatically start the process for distributing the script to the other developers upon creation of the framework. Alternatively, the scripts can be delivered through a source control portion of software 150, described above, and automatically delivered to developers when they rebase to the latest version of the code base.

It should be noted that, unlike existing systems, just as there is no need to compare the developer's local database 212 to a live or master database 112 to generate the migration script, there is no need for the migration script to be uploaded to a server computer 100 for download by the other developers. Thus, access to a server 100 is not necessary for the developers to receive updated schemas from the other developers. Instead, the migration scripts are embedded directly in the framework 220, and distributed, for example, through a code delivery mechanism, electronic mail, or other electronic service. The selected delivery system is used to send the framework 220 directly to each of the other developer's computers 300, step 450.

In one embodiment, the method for generating the electronic message containing the migration script framework 220 includes using Visual Basic to generate a Microsoft Outlook electronic mail attaching the framework 220. Using this method, each developer sets up a developer's Outlook Group containing the e-mail address of the other developers in the group working on the database development project, and having local databases 112 and 312 that need to be updated. In another embodiment, the scripts 220 are deposited into a source control system 150 and delivered to developers during the course of their normal code synchronization activities.

Using computer 300 of FIG. 1 as an example, from the received electronic mail, each developer downloads the migration script framework 220 from the electronic mail for execution and synchronization of their local database 312, step 452. Alternatively, in embodiments using a source control system as the distribution method, the developer synchronizes their local code with a newer version of the product code base. It is typically part of a developer's daily procedures to download all code from a source control system 150, and is hence not intrusive. The migration script framework 220 is downloaded with the code.

Once the framework 220 is at the local computer 200 or 300, the developer can migrate their local database 312 to the updated version defined according to the migration scripts in the framework 220 through, in some embodiments, a command line option to initialize a browser or local schema software 154, step 454. In some embodiments, if a network connection is available, a local computer 200 or 300 may be used to run schema software 150 on a server 100 to cause the migration. For example, if the executable file to run the schema software 150 is called dbmigrate.exe, a user may migrate to the updated version by typing
c:>dbmigrate<dbadmin_password><target_version><dbmigrate.xml>
   where <dbadmin_password> is a password used to open or connect to the local database, <target_version> is a desired schema version if several versions of the database 312 are kept in the rewritable storage device 310, and <dbmigrate.xml> is the XML file 220 holding the migration instructions. Alternatively, an Outlook Rule may be set up in the Outlook program to use a Visual Basic object to automatically download and execute the migration script framework 220. The migration script framework 220 may also be accompanied by a properties file that contains database specifics used by the framework 220 to automatically locate the local database 312 and execute the migration. For example, a corresponding database properties file may contain values called db.name, which is the database name, and db.schema.name, which is a target schema version.

Upon execution of the update, the XML instructions 220 containing the migration scripts 220 are retrieved and parsed, step 456, and the SQL instructions or other executable instructions are executed, step 458. The named or current schema version is retrieved, step 458. If the XML script 220 contains several updates, e.g. several SQL code statements, each ordinal schema version change instruction is located and the corresponding instructions are executed in order until all updates from the XML script 220 are executed and the desired schema version is established in the local database 312.

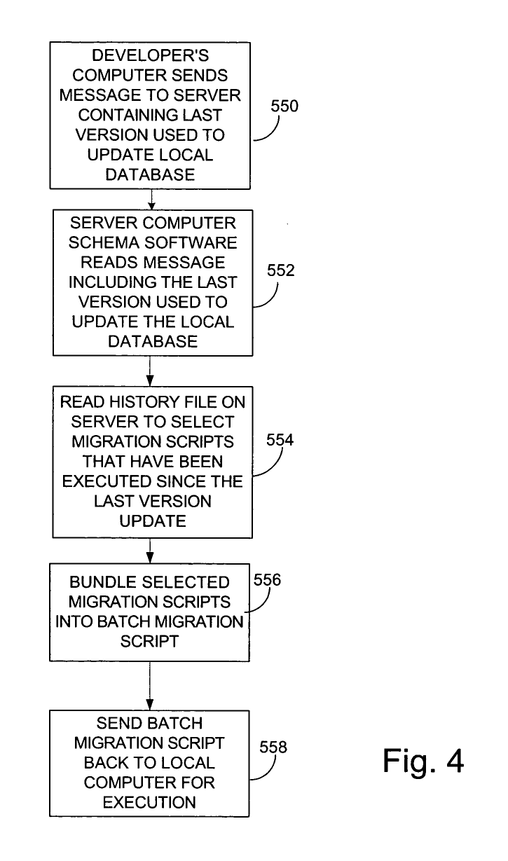

With reference to FIG. 4, instead of automatically updating their respective database schemas as soon as they receive migration script frameworks 220, the developers may simply turn off or not use any automatic reception of the frameworks 220. For example, in embodiments using source control mechanisms (part of software 150), after a developer resolves his or her problems or bugs in the local database 212 or 312, the developer may retrieve the current source code base and invoke the install and upgrade framework 220 as desired. Alternatively, the framework 220 may be used to send a message to the server maintaining the master version on server computer 100, step 550. The message includes an indicator to indicate the current version of the schema used by the developer in his or her respective database copy 212 or 312. This indicator may be as simple as an ordinal number indicating the current schema version set the last time the update and install framework 220 was used to update the developer's local database 212 or 312. The server computer 100 reads the message, including the schema version, step 352, and reads the history file to select all of the migration scripts that have been processed to upgrade the master database 112 to its current schema version since the date and time of the last update of the developer's local database schema, step 354. The framework on the server computer 100 may be used to bundle those selected migration scripts, in order, into one batch migration framework 220, step 556. The bundle is returned to the particular computer 200 or 300 which sent the message to start the upgrade process, step 558. Once the local computer 200 or 300 receives the batch migration script 220, it is executed as described above with respect to FIG. 3.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for synchronization of copies of a database, comprising:
determining changes made to a schema of a first copy of the database;
generating a migration script according to the changes;
incorporating the migration script into a framework;
sending the framework to a location of one or more other copies of the database for executing to update the one or more other copies.

2. The method of claim 1, wherein the migration script includes SQL instructions.

3. The method of claim 1, wherein the migration script includes instructions in the form of a derivative of SQL.

4. The method of claim 1, wherein the migration script includes executable code.

5. The method of claim 4, wherein the executable code comprises Java code.

6. The method of claim 1, wherein the step of reading the changes comprises comparing a stored snapshot of the schema of the first copy of the database to a current schema of the first copy of the database.

7. The method of claim 1, wherein at least one of the one or more other copies of the database comprises a master copy of the database.

8. The method of claim 1, wherein the step of sending comprises sending the framework by electronic mail.

9. The method of claim 1, wherein the step of sending comprises sending the framework through a source code control system.

10. The method of claim 1, wherein the step of sending comprises sending the framework by storing the framework on a floppy disk and sending the floppy disk by a physical mail service.

11. A method for synchronization of one or more copies of a database, comprising:
receiving a framework containing a migration script at a location of a local copy of the database, the migration script representing changes made to a schema of a remote copy of the database; and
executing the framework to update the local copy of the database.

12. The method of claim 11 wherein the migration script includes executable code.

13. The method of claim 12, wherein the executable code comprises Java code.

14. The method of claim 11 wherein the step of receiving comprises receiving the framework by electronic delivery.

15. The method of claim 11 wherein the step of receiving comprises receiving the framework on floppy disk by mail using a physical mail service.

16. A system for synchronization of copies of a database residing at a plurality of locations, comprising:
a database schema reader for allowing a user to determine changes made to a schema of a first copy of the database;
a framework for receiving a migration script generated according to the changes; and
a delivery service for sending the framework to a location of one or more other copies of the database for executing to update the one or more other copies.

17. The system of claim 16, wherein the migration script includes SQL instructions.

18. The system of claim 16, wherein the migration script includes executable code.

19. The system of claim 18, wherein the executable code comprises Java code.

20. The system of claim 16, wherein the schema change tracking software is for reading changes by comparing a snapshot of the schema of the first copy of the database to a current schema of the first copy of the database.

21. The system of claim 16, wherein at least one of the one or more other copies of the database comprises a master copy of the database.

22. The system of claim 16, wherein the delivery service is an electronic mail service.

23. The system of claim 16 wherein the delivery service is a source code control system.

24. The system of claim 16 wherein the delivery service includes a file server.

25. The system of claim 16, wherein the mail service comprises a physical mail service for sending a floppy disk containing the framework.

26. A system for synchronization of one or more copies of a database, comprising:
a receiving device for receiving a framework containing a migration script at a location of a local copy of the database, the migration script representing changes made to the schema of a remote copy of the database; and
a processor for executing the framework to update the local copy of the database.

27. The system of claim 26, wherein the migration script includes executable code.

28. The system of claim 26, wherein the executable code comprises Java code.

29. The system of claim 26, wherein the receiving device comprises an electronic network connection for receiving an electronic message containing the framework.

30. The system of claim 26 wherein the receiving device comprises a source control system from which a code release can be downloaded.

31. The system of claim 26, the receiving device comprises a mailing address location for receiving a floppy disk containing the framework by physical mail.

32. A computer program product having a computer readable medium having computer program logic recorded thereon for synchronization of copies of a database, comprising:
computer readable means for creating a migration script reflecting changes made to a schema of a first copy of the database in including the migration script in a framework;
computer readable means for sending the framework to the location of one or more other copies of the database for executing to update the one or more other copies of the database.

33. The computer program of claim 32, wherein the migration script includes SQL instructions.

34. The computer program of claim 32, wherein the migration script includes executable code.

35. The computer program of claim 34, wherein the executable code comprises Java code.

36. The computer program of claim 32, wherein at least one of the one or more other copies of the database comprises a master copy of the database.

37. The computer program of claim 32, wherein the computer readable means for sending comprises an electronic mail service.

38. The computer program of claim 32, wherein the computer readable means for sending includes source control systems.

39. The computer program of claim 32, wherein the computer readable means for sending includes a file server.

40. The computer program of claim 32, wherein the computer readable means for sending comprises the computer readable means for storing the framework on a floppy disk and for sending the floppy disk by a physical mail service.

41. A computer program product having a computer readable medium having computer program logic delivered and recorded thereon for synchronization of one or more copies of a database, comprising:
computer readable means for receiving framework including a migration script at a location of a local copy of the database, the migration script representing changes made to a schema of a remote copy of the database; and
computer readable means for executing the framework to update the local copy of the database.

42. The computer program of claim 41, wherein the migration script includes executable code.

43. The computer program of claim 41, wherein the executable code comprises Java code.

44. The computer program of claim 41, wherein the computer readable means for receiving comprises a source code control version control system.

45. The computer program of claim 41, wherein the computer readable means for receiving comprises a connection to a file server.

46. The computer program of claim 41, wherein the computer readable means for receiving comprises computer readable means for receiving the framework by electronic mail.

47. The computer program of claim 41, wherein computer readable means for receiving comprises means for reading a floppy disk containing the migration script, floppy disk being received by mail using a physical mail service.

48. A method for synchronization of copies of a database, comprising:
receiving a message containing a last time when a first one of a plurality of stored migration scripts was executed to modify a schema of a first copy of the database;
selecting a subset of the migration scripts of the stored migration scripts to execute on the first copy of the database based on the last time when the first one of the plurality of stored migration scripts was executed; and
executing the selected migration scripts to update the schema of the copy of the database.

49. The method of claim 48, wherein the plurality of migration scripts are stored on a server.

50. The method of claim 48, wherein the plurality of migration scripts comprise migration scripts received from one or more computers containing copies of the database, each migration script representing changes that were made to the copies of the database.

51. The method of claim 50, wherein the sever contains a master copy of the database, the plurality of migration scripts further comprising migration scripts that have been executed on the server computer to update the schema of the master copy of the database.

52. The method of claim 51, comprising bundling the selected migration scripts into a framework.

53. The method of claim 52, comprising sending the framework to a local computer for executing on the local computer, the local computer containing the first copy of the database.

54. A computer program product having a computer readable medium having computer program logic recorded thereon for synchronization of copies of a database, comprising:
computer readable means for receiving a message containing a last time when a first one of a plurality of stored migration scripts was executed to modify a schema of a first copy of the database;
computer readable means for selecting a subset of the migration scripts of the stored migration scripts to execute on the first copy of the database based on the last time when the first one of the plurality of stored migration scripts was executed; and
computer readable means for executing the selected migration scripts to update the schema of the copy of the database.

55. The computer program of claim 54, wherein the plurality of migration scripts are stored on a server.

56. The computer program of claim 55, wherein the plurality of migration scripts comprise migration scripts received from one or more computers containing copies of the database, each migration script representing changes that were made to the copies of the database contained on the one or more computers.

57. The computer program of claim 56, wherein the sever contains a master copy of the database, the plurality of migration scripts further comprising migration scripts that have been executed on the server computer to update the schema of the master copy of the database.

58. The computer program of claim 57, comprising computer readable means for bundling the selected migration scripts into a framework.

59. The computer program of claim 58, comprising computer readable means for sending the framework to a local computer for executing on the local computer, the local computer containing the first copy of the database.
